(19) United States
(12) Patent Application Publication
(10) Pub. No.: US 2007/0057394 A1
(43) Pub. Date: Mar. 15, 2007

(54) Apparatus and method for temperature control

(76) Inventor: Thomas Linehan, Clarkston, MI (US)

Correspondence Address: MILACRON INC., 2090 FLORENCE AVE., CINCINNATI, OH, 45206, US

(21) Appl. No.: 11/226,662

(22) Filed: Sep. 14, 2005

(51) Int. Cl. B29C 45/78

(52) U.S. Cl. 264/40.6; 264/404; 264/328.14; 264/328.16; 425/144; 425/549

(57) ABSTRACT

Improved temperature control for melt distributing equipment for injection molding selects alternative set-point values according to occurrence of injection for heating devices controlled without measured temperature. The set-point values adapt operation of the heating devices to accommodate material heating resulting from flow of melt through the equipment into mold cavities. Occurrence of injection is advantageously determined from control of heating devices using measured temperature by detecting changes of heat producing operation of heating devices and or changes of values used for temperature control of heating devices where the changes are indicative of material heating resulting from flow. For electrical heaters energized by controlled connection to a power source, set-point values are adjusted to correct for variance of the power source voltage.

### BACKGROUND OF THE INVENTION

1. Field of the Invention

This invention relates generally to temperature control of a plant having plural temperature control zones. In particular, this invention relates to control of temperature in injection molding equipment for conveying plasticized material into mold cavities.

2. Description of Related Art

Injection molding is a process wherein raw material in pellet or powder form is converted to a flowable ass known as “melt” in an injection unit and propelled (“injected”) therefrom into cavities of a mold assembly by application of force to the melt. The material is solidified in the mold cavities resulting in one or more molded articles; the molded articles being removed once sufficiently rigid so as to be unacceptably deformed when unsupported. Melt is admitted to the mold cavities via gates, advantageously valved gates, the number and arrangement of gates being determined by the number, volume and shape of the cavities to be filled. Melt is conveyed from the injection unit to the gates by conduits (“runners”) comprising the mold assembly. To prevent melt from solidifying in the conduits, the conduits are maintained at elevated temperatures by application of heat to the mold assembly proximate the runners, such heated runners comprising so-called “hot-runner systems”. As melt is injected, melt self-heating occurs as a consequence of mechanical working of the material as it moves through the conduits. In particular, with changes of direction and changes of conduit cross section proximate gates the material undergoes shear and the resulting friction at the molecular level is converted to heat. Advantageously, temperature of the conduits is controlled to maintain a flowable condition of the melt without overheating that would degrade material the melt comprises. To achieve the desired control of temperature, it is known to use control devices responsive to measured temperature determined using sensors such as thermocouples and resistance temperature detectors. Temperature control is advantageously arranged in zones, each temperature control zone having a controller associated therewith. When measured temperature is not available, due for example to loss of electrical connection to a sensor or failure of a sensor itself, it is known to establish “master/slave” arrangements where a control for a zone with measured temperature is linked to a zone with similar heat transfer characteristics without measured temperature. However, such arrangements require facilities for transferring data between controllers that add to the complexity and cost of individual controls. Hence, there is a need for improved control without temperature measurement for temperature control zones in injection molding equipment where effects of material self heating are significant.

### SUMMARY OF THE INVENTION

It is an object of the present invention to provide improved temperature control for equipment for conveying melt to at least one mold cavity of a mold assembly in an injection molding machine wherein values for control signals for controlling a proportion of heat producing operation of heating devices of the equipment are selected according to the occurrence of injection of melt into the mold cavities;

It is a further object of the present invention to provide improved temperature control for equipment for conveying melt to at least one mold cavity of a mold assembly in an injection molding machine wherein values for control signals for controlling a proportion of power deliverable to electrical heaters of the equipment are adjusted in response to a measured value of delivered power differing from an expected value.

It is a further object of the present invention to provide improved temperature control for equipment for conveying melt to at least one mold cavity of a mold assembly of an injection molding machine wherein temperature is controlled in plural zones, at least one zone temperature is controlled in response to measured temperature and the occurrence of injection of melt is determined from a change in the heat producing operation of the heating devices of that zone and selection of a value for a control signal for a zone controlled without measured temperature is made in response to the determination of occurrence of injection in the temperature controlled zone.

Further objects and advantages of the invention shall be made apparent from the accompanying drawings and the following description thereof.

In accordance with the aforesaid objects the present invention provides temperature control for equipment for conveying melt to at least one mold cavity of a mold assembly in an injection molding machine, temperature control apparatus comprising a memory for storing first and second alternative proportioning set point values, the first alternative proportioning set point value defining the proportion of heat producing operation to be effective when melt is being injected into the mold cavities, the second alternative proportioning set point value defining the proportion of heat producing operation to be effective other than when melt is being injected into the mold cavities and a processor for producing a control signal for controlling a proportion of heat producing operation of a heating device in response to one of the first and second alternative proportioning set point values according to whether melt is being injected into the mold cavities. Where the heating device is an electrical heater, the control signal is effective to control the proportion of electrical power deliverable by an interface device to be dissipated in the electrical heater and the control advantageously comprises a sensor for measuring a value of one of electrical current delivered to the heater and electrical voltage of the electrical current source and the processor adjusts the control signal when the measured value differs from the expected value.

### BRIEF DESCRIPTION OF THE DRAWINGS

FIG. 1 is a block diagram of a modular hot runner system in accordance with the invention.

FIG. 2 is a block diagram of an integrated hot runner system in accordance with the invention.

FIG. 3 is a block diagram of power interface circuitry of the control devices of FIGS. 1 and 2.

FIG. 4 is a flow chart illustrating a procedure for selecting proportioning set point values.

FIG. 5 is a flow chart illustrating a procedure for determining when injection is occurring from values associated with control of heaters.

FIG. 6 is a flow chart illustrating a procedure for adjusting proportioning set point values for source voltage variance.

### DETAILED DESCRIPTION OF THE PREFERRED EMBODIMENT

The invention shall be illustrated with reference to preferred embodiments which shall be described in detail. The illustration and description of the preferred embodiments is intended only to provide information to assist in understanding of the invention. It is not the intention of applicant that the invention be limited to a preferred embodiment, but rather that the invention shall be defined by the appended claims and all equivalents thereof.

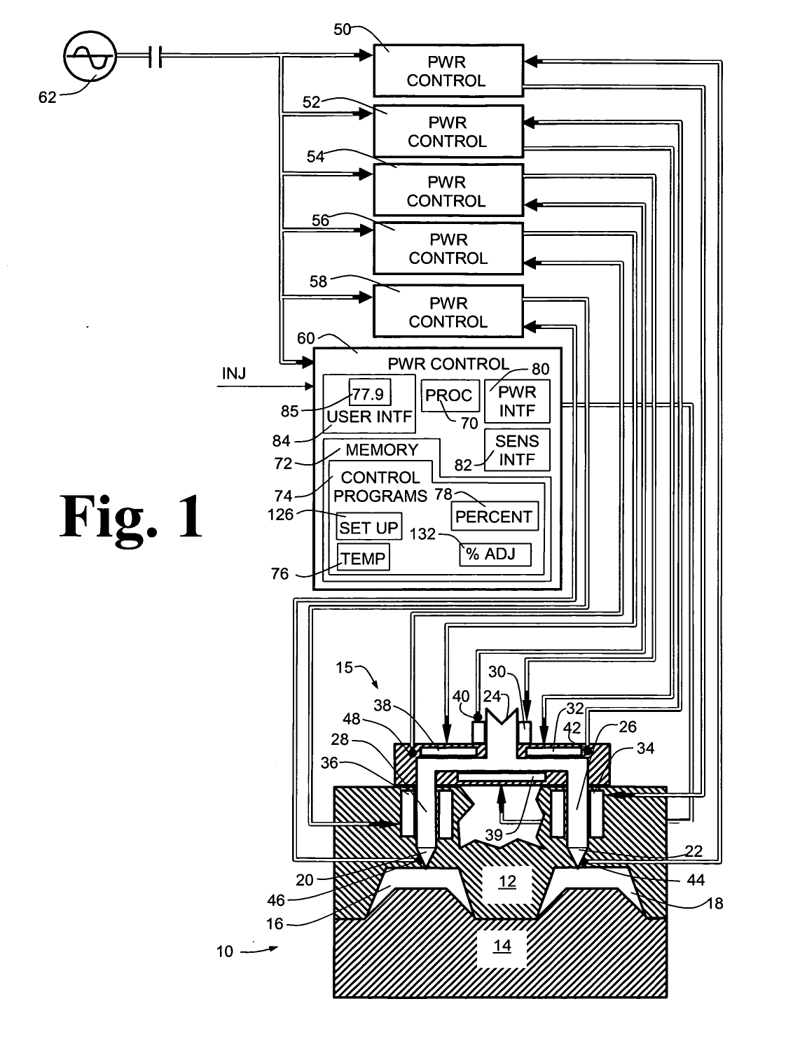

Referring to FIG. 1, a mold assembly 10 comprises mold halves 12 and 14 defining mold cavities 16 and 18 along the parting line of the mold halves. Mold halves 12 and 14 are shown in cross-section and mold half 12 is shown with a partial cut-away. Cavities 16 and 18 determine the shape, size and finish of articles to be molded using mold assembly 10. Molding is effected by introduction of flowable material into cavities 16 and 18, solidification of the flowable material, and separation of mold halves 12 and 14 to permit removal of the solidified articles. A hot runner system 15 comprises inlet 24, channels 26 and 28, and nozzles 20 and 22. Flowable material is introduced to hot runner system 15 at inlet 24 and is directed through channels 26 and 28 to nozzles 20 and 22 from which it enters cavities 16 and 18 of mold assembly 10. In connection with the present invention, the flowable material of interest is molten, the so-called “melt”, and may be, for example, metal, rubber, or thermoplastic. Solidification of the melt may be accelerated by removal of heat from mold assembly 10 by conducting heat transfer fluid through channels (not shown) proximate cavities 16 and 18.

Continuing with reference to FIG. 1, it is to be understood that complete filling of cavities 16 and 18 is essential to producing articles of acceptable quality. Hence, it is desirable to maintain the flowable condition of the melt from inlet 24 through nozzles 20 and 22 to cavities 16 and 18. With thermoplastic material, it is necessary to control temperature of the melt within a relatively narrow range to maintain the desired flowable condition of the material without overheating to the point where degradation of components of the material will occur. Heat lost during conveyance of melt through hot runner system 15 is replaced by heat supplied from heaters 30, 32, 34, 36, 38 and 39. In addition, as melt moves through hot runner system 15 it undergoes mechanical working including shear attributable to changes of direction and changes of cross section of the conduits and nozzles. The mechanical working contributes to material self heating. The arrangement of elements of hot runner system 15 is advantageously associated with temperature control zones, each temperature control zone being associated with at least one of heaters 30-39.

Continuing with reference to FIG. 1, heaters 30-39 convert electrical energy to heat. Each of controllers 50-60 are interconnected with a heater to control application of electrical energy from source 62 to one of heaters 30-39. Electrical energy from source 62 may be supplied as alternating current, as indicated in FIG. 1 or may be supplied as direct current. Advantageously, source 62 supplies poly-phase alternating current permitting distribution of electrical loads among the phases of the supply. Regulation of the application of power may be achieved as a proportion of available energy that can be delivered by a control or in accordance with measured temperature associated with a temperature control zone. Temperature proximate the heaters is sensed by, for example, sensors 40, 42, 44, 46, and 48. Temperature sensors may be thermocouples or resistance temperature detectors as are well known, and each is interconnected with the one of power controls 50-60 that control application of electrical energy to a heater having the greatest affect on the temperature sensed. Each of power controls 50-60 is capable of controlling application of power according to a control algorithm relating measured temperature and a desired or set point temperature. Advantageously, a temperature control algorithm using measured temperature affected by the controlled heater comprises proportional, integral and derivative control to achieve prompt convergence of actual temperature to a set-point value without unacceptably high temperature excursions. For heaters for which measured temperature is available, each of controls 50-60 is capable of controlling application of power to a heater according to a desired or set point proportion (percentage) of the power deliverable by the control to the associated heater. When operated to deliver a percentage of available electrical power, the delivered power will be between 0% and 100% of available power deliverable by the control. As no temperature sensor is connected to power control 60 (shown connected to deliver power to heater 39), control 60 would be operated to deliver a proportion of the associated deliverable power capacity.

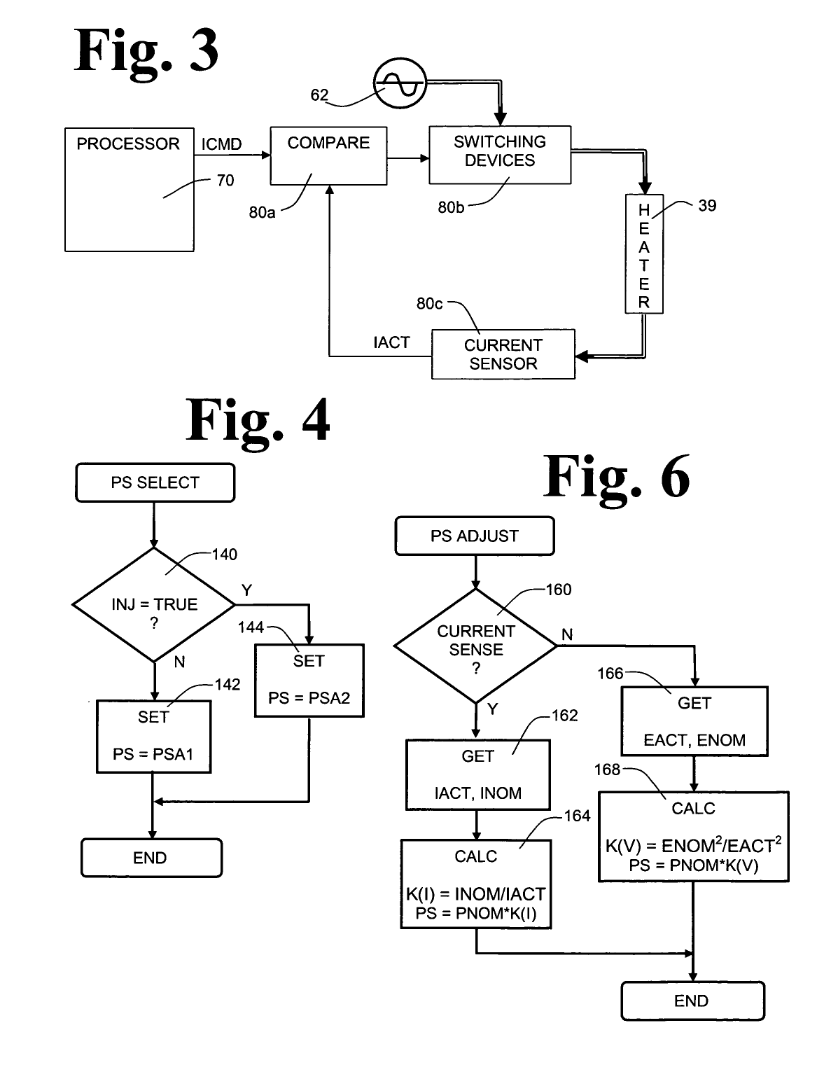

Referring to FIGS. 1 and 3 each of power controls 50-60 advantageously comprise programmable devices executing programs implementing control algorithms. As an example, power control 60 is illustrated as comprising processor 70 and memory 72 wherein are stored control programs 74 including temperature control programs 76 implementing a temperature control algorithm, proportional control programs 78 implementing a proportional (percentage) power control algorithm, and proportional adjustment programs 132 implementing correction of the proportioning set point for variance of voltage of the power source. While shown as separate elements, processor 70 and memory 72 may comprise a single device wherein digital representations of set point values and measured temperature are used. In addition, power control 60 comprises power interface circuitry 80 for transferring power from source 62 to the connected heater according to the effective control algorithm. Power interface circuitry 80 converts a power proportioning value produced by execution of a control algorithm to a control signal to control a power switching device to apply power to the load.

Continuing with reference to FIG. 1, power control 60 further comprises sensor interface 82 for receiving signals from a temperature sensor (none connected to power control 60 as shown in FIG. 1). Set point values are advantageously varied according to the mode of operation of hot runner system 15. Each of power controls 50-60 advantageously includes a user interface 84 comprising devices for facilitating setting of set-point values, such as a numeric display 85 and electrical switching devices. Numeric display 85 advantageously displays values stored in memory 72 as well as selected values of measured parameters.

Referring to FIG. 3, power interface circuitry 80 comprises switching devices 80b, advantageously, semiconductor devices, that are selectably conductive to electrically connect source 62 to a heater such as heater 39. Switching devices 80b are controlled to be conductive as required to achieve a desired power dissipation in the controlled heater. Where source 62 supplies alternating current, the power switching device may control the portion of a cycle of the source voltage conducted by the device from the source to the load, so called phase-angle control, as is well known. Alternatively power dissipated in the load may be controlled on a time interval basis wherein the power switching device conducts for a percentage of the period of a predetermined time interval. Where source 62 supplies alternating current, time interval based control advantageously delivers full cycles of alternating current during conduction, as is well known. As illustrated by the block diagram of FIG. 3, the current command ICMD represents the electrical current to be delivered to heater 39 by switching devices 80b to achieve the set point proportion of power dissipation in heater 39. Electrical current being conducted through heater 39 is represented by a signal IACT produced by current sensor 80c. The command value ICMD is compared with the measured value in comparator 80a to produce a control signal for controlling conduction of switching devices 80b.

In accordance with the invention, the control of power applied to heater 39 by control 60 is improved by correction for variations of voltage supplied by source 62. As switching devices 80belectrically connect source 62 to heater 39, voltage variance will be reflected in electrical current conducted by heater 39, resulting in a change of power dissipated by heater 39. To correct for source voltage variance, the power proportioning set point used for controlling energy delivered to heater 39 is adjusted according to:
PS=PNOM*K(I) Equation (1)
K(I)=INOM/IACT
Where:
IACT is the measured value of current delivered to the load
INOM is the nominal (expected) current to be delivered to the load at the nominal voltage of source 62
PS is the power proportioning set point
PNOM is the power proportioning value for electrical current equal to INOM
* designates multiplication
/ designates division

In the event measured current is not available, but a measure of voltage from source 62 is available, adjustment of the power proportioning value is effected according to:
PS=PNOM*K(V) Equation (2)
K(V)=ENOM**2/EACT**2
Where:
EACT is the measured value of voltage of source 62
ENOM is the nominal (expected) value of voltage of source 62
PS is the power proportioning set point
PNOM is the power proportioning value for source voltage equal to ENOM
* designates multiplication
** designates exponentiation
/ designates division

It is to be understood that the effective control parameters produced by power controls 50-60 vary according to the mode of control effected and activity within the zone. For example, during start-up it is desirable to add heat as rapidly as possible to bring hot runner system 15 to an operating temperature. During idle, less heat may be required from heaters 30-39 to maintain a desired temperature, particularly in systems that include equipment for rapidly removing heat from mold assembly 10 that are inactive in idle mode. In normal or automatic mode, the effective control parameter will vary according to changing activity during a normal cycle of operation. Considering hot runner system 15, melt retained in channels 26 and 28 after cavities 16 and 18 are filled, is maintained at a desired temperature primarily through addition of heat from heaters 32-39. During injection, flowing melt undergoes mechanical shear producing heat, the shear and attendant heat being particularly significant in the vicinity of nozzles 20 and 22 where the cross-section narrows to the final orifice at the mold cavities and expands on entering the cavities. Shear heating significantly reduces the need for added heat from local heaters, such as heaters 34 and 36. Hence during a normal cycle of operation, the effective control parameter can vary significantly during mold filling.

In accordance with the invention, to improve temperature control for zones for which measured temperature is not available, a control algorithm accommodates material self heating during injection by permitting application of alternative power proportioning set points according to whether injection is occurring. In the absence of temperature measurement, control is effected by controlling a percentage of available electrical power to be dissipated in the heaters affecting temperature in a zone. Referring to FIG. 1, power control 60 effects control for heater 39. A first alternative power set-point is established for operation when injection is occurring and a second alternative power set-point is established for operation other than during injection of melt. Control 60 executes control in response to the first and second alternative set-points in response to determination of when injection is occurring. Occurrence of injection is advantageously represented by an injection signal INJ associated with control of injection and input to control 60. Alternatively, determination of melt flow associated with injection is advantageously determined from changes in temperature control in a temperature control zone having a controller responsive to measured temperature. A controller for that zone will detect relevant changes and produce a signal indicative of the occurrence of material self-heating associated with injection of melt into mold cavities.

Primary Programmable Control

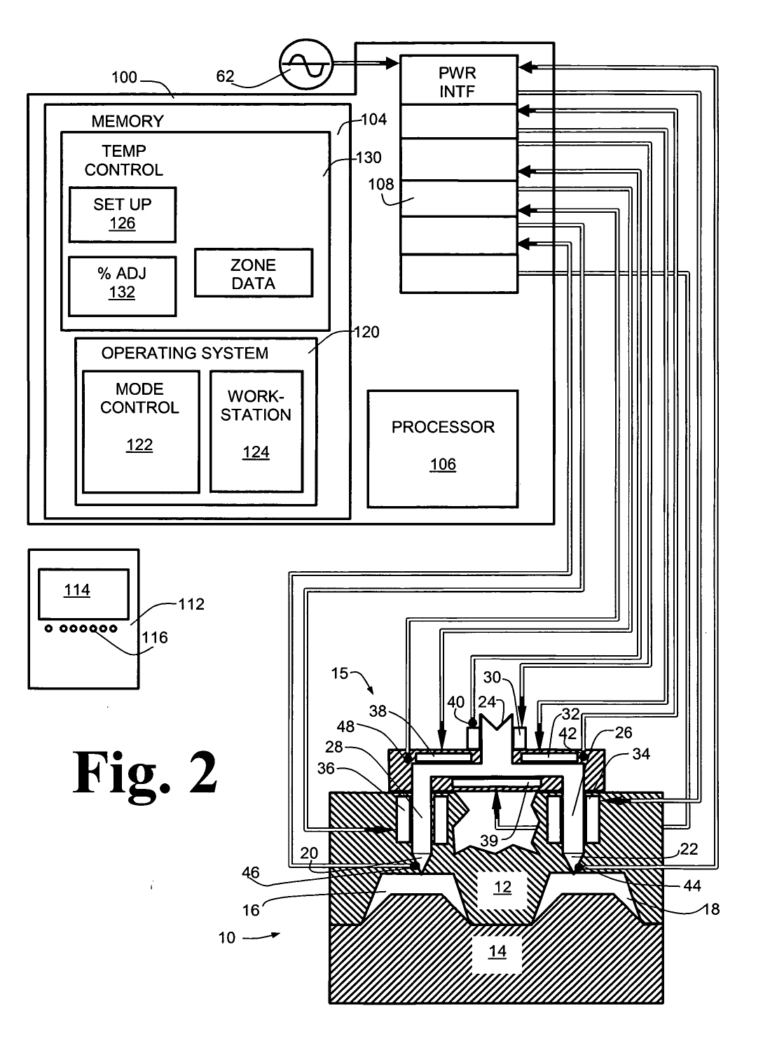

Application of the invention to a hot runner system comprising a primary programmable control shall be described with reference to the block diagram of FIG. 2. Elements of FIG. 2 corresponding to elements of FIG. 1 are shown with the same reference numbers. A programmable control 100 comprises memory 104, a processor 106, and input and output interface devices such as power interface devices 108, all of the foregoing interconnected by, for example, one or more busses to transfer data and addresses. Power interface devices 108 comprise power interface circuitry corresponding to FIG. 3. An operator terminal 112 includes a display 114 and input devices such as keys 116. Operator terminal 112 permits display of data retrieved from memory 104 or created using keys 116 and entry of data to memory 104. Operator terminal 112 may be dedicated to control 100 or may be a portable device which is connected with control 100 only as needed for, for example, set up or maintenance of control 100. Processor 106 is a program controlled device which executes operating system programs 120 to effect control of devices connected to the control busses and to effect control of execution of other programs recorded in memory 104. Operating system programs 120 include mode control programs 122 which control the selection of control programs available for execution according to the operator determined mode of operation of the control, and workstation programs 124 which support exchanges of data with operator terminal 112.

Interface devices 108 comprise plural independently controllable devices for delivering power from source 62 to heaters 30-39. These devices are controlled by program control effected by processor 106 executing programs, such as temperature control programs 130. Although represented in FIG. 2 by a single block, processor 106 may be a combination of plural processors, some of which serve primarily to support input and output of data between memory 104 and operator terminal 112 and others serving primarily to effect control of devices of interface devices 108. In particular, processor 106 may include a plurality of independent processors associated with power interface devices 108. Likewise, while memory 104 is represented in FIG. 2 by a single block, memory 104 may be a combination of plural memory devices, some of which serve primarily to store programs and data associated with functions involving operator terminal 112 and other devices serving to store programs and data associated with control of devices of interface devices 108. In particular, memory 104 may include a plurality of independent memory devices associated with power interface devices 108.

Program control of heaters 30-39 is effected in a “normal” or “automatic” mode of operation selected by the operator. Power applied to the heaters in this mode is controlled by execution of temperature control programs 130. Control of the hot runner system is effected by execution of, for example, a set up program 126 for establishing set point values used to control zone heating. A source of electrical energy 62 is connected to power interface devices 108. Power interface devices 108 may comprise plural independent program controlled devices (combinations of processors and memory), each effecting control of electrical energy applied to one of heaters 30-39 to maintain sensed temperature within a working tolerance of the applicable temperature set point. Equivalent operation can be achieved wherein a single program controlled device (combination of memory and processor) evaluates plural algorithms and sequentially produces plural control signals, one to control power applied from source 62 to each of heaters 30-39.

To effect program control, processor 106 executes programs to evaluate control algorithms relating, for example, set point values, sensed values and controlled values. Plural algorithms may be employed to effect control of power applied to a single heater according to, for example, applicable conditions of the hot runner system. Hence, different algorithms may be employed for control under “start-up”, “steady-state”, and “idle” operation of any of heaters 30-39. In addition, different algorithms are employed to effect temperature responsive control using a temperature set point and sensed temperature and proportional control responsive to a proportioning set point. In accordance with the nature of the control algorithm used, set point values may be defined for: (i) temperatures for cold start up, normal, and idle operation; (ii) limits of electrical current delivered to the connected heater; (iii) control algorithm parameters such as gain (proportional constant), integral constants and differential constants; (iv) load resistance; (v) load power; (vi) thermal response lag time; and, (vii) average power to maintain temperature set point. Set point values are associated with each zone, each zone having a unique identifier such as a zone number. Set point data are advantageously stored to permit retrieval using an index defined by an appropriate zone identifier.

Programmed Procedures

Program control is advantageously effected by control processors performing digital operations, including both mathematical and logical operations. Digital representations of measured values are produced by periodic sampling of sensor signals, the frequency of sampling being chosen according to the desired precision of the digital representation and the highest anticipated rate of change of the sensed parameter. Digital representations of set point values, constants, and parameter values comprising commissioning data are advantageously stored in memory and retrieved therefrom as needed in the course of execution of control algorithms. As is customary, digital operations are repetitively performed at a predetermined rate of repetition and subject to logical control of procedural steps executed with each repetition. The flow charts of FIGS. 4-6 represent procedures advantageously executed by control processors performing digital operations.

Referring to FIG. 4, a procedure for selecting an alternative proportioning set point value in accordance with the invention begins at decision step 140 where it is determined whether the value of the signal (“INJ”) representing injection of melt into the mold cavities is true. As illustrated in FIG. 1, this signal is advantageously an input to a control module from the injection molding machine. Had it been determined at decision step 140 that melt is not being injected into the mold cavities, the proportioning set point (PS) is set equal to the first alternative proportioning set point value (PSA1) at step 142. Had it been determined at decision step 140 that melt is being injected into the mold cavities, the proportioning set point (PS) is set equal to the second alternative proportioning set point value (PSA2) at step 144. The selected value of the proportioning set point is then applied by the control processor to control the delivery of power to the heaters of the affected temperature control zone.

In the event a signal is not available that indicates injection is occurring, signals associated with the control of heat producing devices such as heaters 30-39 may be used to detect injection of melt into the mold cavities. Bearing in mind that material self-heating can result in a relatively rapid rise of melt temperature, a consequence thereof is a relatively rapid decrease in required additional heat to maintain a desired temperature of melt. Material heating attributable to shear is advantageously detected from reductions in required heat producing operation of controlled heating devices where control is effected in response to measured zone temperature. In general, selection of an alternative proportioning set point value by detection of shear heating during injection can be effected in accordance with the following:
IF P(1)−P(2)<LIMS(P), PS=PSA1
IF P(1)−P(2)≧LIMS(P), PS=PSA2
Where:
LIMS(P) is a limit value of heat producing operation change over time associated with injection of melt into the mold cavities
P(1) is the value of the heat producing operation of the controlled heating device at the beginning of a predetermined time interval ΔTP
P(2) is the value of the heat producing operation of the controlled heating device at the end of a predetermined time interval ΔTP
PS is the proportioning set point
PSA1 is the first alternative proportioning set point value
PSA2 is the second alternative proportioning set point value

In the case where additional heat is produced by electrical heaters such as heaters 30-39, reduced heat producing operation may be determined directly from electrical power dissipated in the heater. Power dissipated in a heater is computed from electrical current delivered in accordance with:
P=(IACT**2)*R Equation (3)
Where
P is the power dissipated
IACT is the electrical current delivered to the heater
R is the resistance of the heater
* designates multiplication
** designates exponentiation
   Shear heating is detected from power dissipated in a heater in accordance with:
   P(1)−P(2)≧LIMS(P)
Where
P(1) is the power dissipated at the beginning of a predetermined time interval (ΔTP)
P(2) is the power dissipated at the end of the predetermined time interval (ΔTP)
LIMS(P) is a predetermined magnitude of decrease of power occurring within the time interval (ΔT) that is chosen as indicating the occurrence of shear heating

Alternatively, shear heating may be detected from values of an algorithm executed to control heat producing operation of a controlled heating device in response to measured zone temperature. Advantageously, an algorithm using measured temperature and comprising one or more of proportional, integral and derivative terms provides suitable values for detecting shear heating. An implementation of such an algorithm for execution by digital processors is of the form:
POUT=VP+VI+VD
Where
POUT is a percentage of heat producing operation of a controlled heating device (0≦POUT≦100)
VP is the proportional term=KP*TE(t)
   KP is the constant of proportionality of the proportional term
   TE(t) is the difference between actual temperature and set-point temperature at time “t”
VI is the integral term=KI*S(t)
   KI is the constant of proportionality of the integral term
   S(i) is a sum at the “i^{th}” computation=S(i−1)+TE*(Δti)
   S(i−1) is the value of S from the immediately preceding computation of S
   Δti is the computational time interval of the integral term
VD is the derivative term=KD(TE(d)−TE(d−1))/(Δtd)
   KD is the constant of proportionality of the derivative term
   TE(d) is the difference between actual temperature and set-point temperature at the
   “d^{th}” computation of VD
   TE(d−1) is the difference between actual temperature and set-point temperature at the immediately preceding computation of VD
   Δtd is the computational time interval of the derivative term
      The constants of proportionality KP, KI and KD together with the computational intervals Δti and Δtd are chosen to promptly converge temperature to the set-point value without unacceptably high temperature excursions above the set-point temperature, as is known for such temperature control algorithms. In digital implementations, values of VP, VI and VD are periodically computed using values of periodic samples of temperature and the applicable constants. Shear heating is detected using values of any of the proportional, integral or derivative terms of the algorithm in accordance with:
      V(1)−V(2)≧LIMS(V)
      Where
V(1) is the value of any of VP, VI and VD at the beginning of a predetermined time interval (ΔTV)
V(2) is the value of the same variable at the end of the predetermined time interval (ΔTV)
LIMS(V) is a predetermined change of magnitude of the selected proportional, integral or derivative value occurring within the time interval (ΔTV)
ΔTV is a predetermined time interval during which a reduction of heat producing operation of magnitude LIMS(V) reflects shear heating
   As applied to the control of electrical heaters 30-39, POUT is the proportion of power deliverable by the control to be dissipated in the affected heater. The procedure for detection of shear heating is equally applicable to control of proportion of heating or cooling production of alternative devices, such as heat transfer devices wherein heat is transferred to or removed from molding equipment by conduction of a heat transfer fluid through the equipment and one or more heating and/or cooling devices. Control of a proportion of heating or cooling production can be effected by control of flow of the heat transfer fluid through the equipment and heating/cooling devices. Hence, a proportion of heating/cooling production is controlled by controlling proportion of flow of heat transfer fluid through heat transfer elements proximate melt conducting components of the equipment.

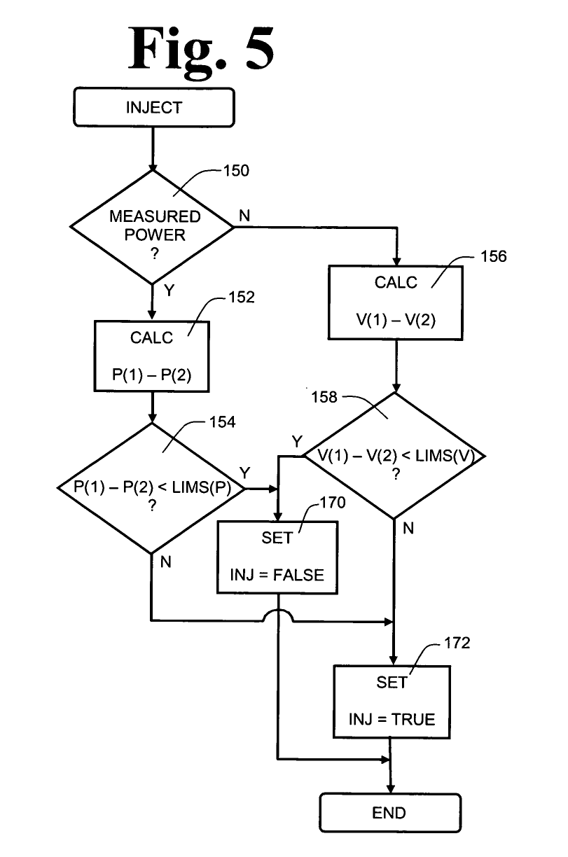

Referring to FIG. 5, a procedure is illustrated for detecting the occurrence of shear heating. Decision step 150 represents selection of a procedure using measured power or of a procedure using values from a power control algorithm. If measured current is available for computation of power dissipated in a heater, direct power measurement proceeds with computation of power dissipated in a particular heater in accordance with Equation 3. At process step 152 the change in power dissipated in the selected heater occurring over a predetermined time interval ΔTP is calculated as the difference between P(1) and P(2). Decision step 154 represents detection of a change in dissipated power over the predetermined time interval ΔTP equal to or greater than a limit value LIMS(P) corresponding to a magnitude of change associated with shear heating. If the change in power is less than the limit value, shear heating is not occurring and the injection signal INJ is set false at process step 170. If it had been determined at decision step 154 that the change in dissipated power was greater than or equal to the limit value LIMS(P), the injection signal INJ would be set true at process step 172.

Continuing with reference to FIG. 5, were measured current not available for computation of power dissipated in a heater, detection of shear heating would proceed on the basis of determining a change of value of a term of a temperature control algorithm. Each of the proportional, integral and derivative terms of the control algorithm is variable with time. At process step 156 a change of value of one of the proportional, integral and derivative terms occurring over a predetermined time interval ΔTV is calculated. Decision step 158 represents detection of a change in the variable value over the predetermined time interval ΔTV equal to or greater than a limit value LIMS(V) corresponding to a magnitude of change associated with shear heating. If the change in variable value is less than the limit value, shear heating is not occurring and the injection signal INJ is set false at process step 170. If it had been determined at decision step 158 that the change in dissipated power was greater than or equal to the limit value LIMS(P), the injection signal INJ would be set true at process step 172.

A procedure implemented by proportional adjustment programs 132 (FIGS. 1 and 2) to adjust proportioning set point values for variations of voltage from source 62 is represented by the flow chart of FIG. 6. Assuming heater resistance is constant, variations of source voltage will result in variations in current delivered to the load as a consequence of electrical connection of source 62 with a heater by switching devices 80b. In controls equipped with current sensing, adjustment can be made in response to detection of current variations attributable to source voltage variations. Referring to FIG. 6, decision step 160 represents determination of whether or not the control of interest is equipped with current sensing. If so, values of measured electrical current delivered to the load (IACT) and expected current (INOM) are retrieved at step 162. In the event source 62 is an alternating current source, the measured electrical current value IACT varies continuously with voltage. As the expected electrical current value is advantageously a root mean square (RMS) value (direct current equivalent) derived from the poop mean square value of source voltage and heater resistance, measured current is converted to a root mean square value for comparison according to:
IACT(rms)=MAX(IACT)*(0.707)
Where
   IACT(rms) is the RMS value of IACT
   MAX(IACT) is the maximum magnitude of IACT
   * designates multiplication
      Step 164 represents the calculation of an adjustment factor (“K”) in accordance with equation 1, the factor calculated according to the power dissipated in the affected heater by the delivered electrical current IACT (IACT(rms) for alternating current). Had it been determined at decision step 160 that the control was not equipped with current sensing, adjustment of the proportioning set point value is effected using values of the expected (ENOM) and measured (EACT) voltage of source 62 retrieved from memory at step 166. In the event that source 62 is an alternating current source, the measured voltage value EACT varies continuously. As the expected voltage value ENOM is advantageously a root mean square equivalent, the measured voltage value EACT is converted to a root mean square value for comparison according to:
      EACT(rms)=MAX(EACT)*(0.707)
Where
   EACT(rms) is the RMS value of EACT
   MAX(EACT) is the maximum magnitude of EACT
   * designates multiplication
      Step 168 represents the calculation of an adjustment factor (“K”) in accordance with equation 2, the factor calculated according to power dissipated in the affected heater by the application of the source voltage EACT (EACT(rms) for alternating current).

What is claimed is:

1. Apparatus for temperature control for equipment for conveying melt to at least one mold cavity of a mold assembly in an injection molding machine, the apparatus comprising:
(a) a memory for storing first and second alternative proportioning set point values, the first alternative proportioning set point value defining the proportion of heat producing operation to be effective when melt is being injected into the mold cavities, the second alternative proportioning set point value defining the proportion of heat producing operation to be effective other than when melt is being injected into the mold cavities;
(b) a processor for producing a control signal for controlling a proportion of heat producing operation of a heating device in response to one of the first and second alternative proportioning set point values according to whether melt is being injected into the mold cavities.

2. The apparatus according to claim 1 wherein the injection molding machine produces an injection signal representing the occurrence of injection of melt into the mold cavities and the processor is responsive to the injection signal for selecting the one of the first and second proportioning set point values to control the heating device.

3. The apparatus according to claim 1 wherein the heating device is an electrical heater and the control signal is effective to control the proportion of electrical power deliverable by an interface device to be dissipated in the electrical heater.

4. The apparatus according to claim 3 further comprising a sensor for measuring a value of one of electrical current delivered to the heater and electrical voltage of the source of electrical current and the processor adjusts the proportioning set-point values in response to the measured value differing from expected value.

5. The apparatus according to claim 4 wherein the sensor measures electrical current delivered to the heater and the processor adjusts the proportioning set point in accordance with the following:
PS=PNOM*K(I)
K(I)=INOM/IACT
Where:
IACT is the measured value of electrical current delivered to the heater
INOM is the value of electrical current expected to be delivered to the heater
PS is the power proportioning set point
PSNOM is the power proportioning value for an electrical current equal to
INOM
* designates multiplication
/ designates division.

6. The apparatus according to claim 4 wherein the sensor measures electrical voltage of the source of electrical current and the processor adjusts the proportioning set point in accordance with the following:
PS=PNOM*K(V)
K(V)=ENOM**2/EACT**2
Where:
EACT is the measured value of electrical voltage delivered to the heater
ENOM is the value of electrical voltage expected to be delivered to the heater
PS is the power proportioning set point
PNOM is the power proportioning value for a source voltage equal to ENOM
* designates multiplication
** designates exponentiation
/ designates division.

7. The apparatus according to claim 1 further comprising plural temperature control zones, each zone having associated therewith a controlled heating device for affecting temperature within the zone and at least one zone has associated therewith a sensor for measuring temperature, and the processor controls operation of the controlled heating device for the zone with the temperature measuring sensor according to an algorithm relating set point temperature and measured temperature.

8. The apparatus according to claim 7 wherein the processor detects injection of melt into mold cavities from a reduction of heat producing operation of the controlled heating device in a zone controlled in accordance with an algorithm relating set point temperature and measured temperature, and the selection of a set point for a zone for which measured temperature is not available is made in accordance with the following:
IF P(1)−P(2)<LIMS(P), PS=PSA1
IF P(1)−P(2))≧LIMS(P), PS=PSA2
Where:
LIMS(P) is a limit value of heat producing operation change over time associated with injection of melt into the mold cavities
P(1) is the value of the heat producing operation of the controlled heating device in a zone controlled in response to measured temperature at the beginning of a predetermined time interval ΔTP
P(2) is the value of the heat producing operation of the controlled heating device in the same zone at the end of a predetermined time interval ΔTP
PS is the proportioning set point for a zone controlled without measured temperature
PSA1 is the first alternative proportioning set point value
PSA2 is the second alternative proportioning set point value.

9. The apparatus according to claim 8 wherein the controlled heating device is an electrical heater and the value of the heat producing operation is computed in accordance with:
P=(IACT**2)*R
Where
IACT is electrical current delivered to the heater
R is electrical resistance of the heater
* designates multiplication
** designates exponentiation.

10. The apparatus according to claim 7 wherein the processor detects injection of melt into mold cavities from a reduction of heat producing operation of the controlled heating device in a zone controlled in accordance with an algorithm relating set point temperature and measured temperature, and the selection of a set point for a zone for which measured temperature is not available is made in accordance with the following:
IF V(1)−V(2)<LIMS(V), PS=PSA1
IF V(1)−V(2)≧LIMS(V), PS=PSA2
Where:
LIMS(V) is a limit value of control variable change over time associated with injection of melt into the mold cavities
V(1) is the control variable value at the beginning of a predetermined time interval ΔTP for the zone controlled in response to measured temperature
V(2) is the control variable value at the end of a predetermined time interval ΔTP for the same zone
PS is the proportioning set point
PSA1 is the first alternative proportioning set point value
PSA2 is the second alternative proportioning set point value and the variable V is one of the proportional, integral and derivative terms of a control algorithm of the form:
POUT=VP+VI+VD
In which
POUT is a percentage of heat producing operation of a controlled heating device (0<POUT<100)
VP is the proportional term=KP*TE(t)
KP is the constant of proportionality of the proportional term
TE(t) is the difference between actual temperature and set-point temperature at time “t”
VI is the integral term=KI*S(t)
KI is the constant of proportionality of the integral term
S(i) is a sum at the “i^{th}” computation=S(i−1)+TE*(Δti)
S(i−1) is the value of S from the immediately preceding computation of S
Δti is the computational time interval of the integral term
VD is the derivative term=KD(TE(d)−TE(d−1))/(Δtd)
KD is the constant of proportionality of the derivative term
TE(d) is the difference between actual temperature and set-point temperature at the “d^{th}” computation of VD
TE(d−1) is the difference between actual temperature and set-point temperature at the immediately preceding computation of VD
Δtd is the computational time interval of the derivative term.

11. Method for temperature control for equipment for conveying melt to at least one mold cavity of a mold assembly in an injection molding machine, the method comprising:
(a) storing first and second alternative proportioning set point values, the first alternative proportioning set point value defining the proportion of heat producing operation to be effective when melt is being injected into the mold cavities, the second alternative proportioning set point value defining the proportion of heat producing operation to be effective other than when melt is being injected into the mold cavities;
(b) producing a control signal for controlling a proportion of heat producing operation of a heating device in response to one of the first and second alternative proportioning set point values according to whether melt is being injected into the mold cavities.

12. The method according to claim 11 wherein the injection molding machine produces an injection signal representing the occurrence of injection of melt into the mold cavities and the one of the first and second proportioning set point values is selected in response to the injection signal produced by the injection molding machine.

13. The method according to claim 11 wherein the heating device is an electrical heater and the control signal is effective to control a proportion of electrical power deliverable by an interface device to be dissipated in the electrical heater.

14. The method according to claim 13 wherein the value of one of the electrical current delivered to the heater and electrical voltage of the source of electrical current is measured and the proportioning set-point value is adjusted in response to the measured value differing from the expected value.

15. The method according to claim 14 wherein the value of electrical current delivered to the load is measured and the proportioning set point is adjusted in accordance with the following:
PS=PNOM*K(I)
K(I)=INOM/IACT
Where:
IACT is the measured value of electrical current delivered to the heater
INOM is the value of electrical current expected to be delivered to the heater
PS is the power proportioning set point
PNOM is the power proportioning value for an electrical current equal to
I(NOM)
* designates multiplication
/ designates division.

16. The method according to claim 14 wherein the value of the electrical voltage of the source of electrical current is measured and the proportioning set point is adjusted in accordance with the following:
PS=PNOM*K
K=ENOM**2/EACT**2
Where:
EACT is the measured value of electrical voltage delivered to the heater
ENOM is the value of electrical voltage expected to be delivered to the heater
PS is the power proportioning set point
PNOM is the power proportioning value for a source voltage equal to ENOM
* designates multiplication
** designates exponentiation
/ designates division.

17. The method according to claim 11 wherein temperature is controlled in plural zones, each zone having associated therewith a controlled heating device for affecting temperature within the zone and at least one zone has associated therewith a sensor for measuring temperature, and the operation of the controlled heating device for the zone with the temperature measuring sensor is controlled according to an algorithm relating set point temperature and measured temperature.

18. The method according to claim 17 wherein the occurrence of injection of melt into mold cavities is detected from a reduction of heat producing operation of the controlled heating device in a zone controlled in accordance with an algorithm relating set point temperature and measured temperature, and the selection of a set point for a zone for which measured temperature is not available is made in accordance with the following:
IF P(1)−P(2)<LIMS(P), PS=PSA1
IF P(1)−P(2)≧LIMS(P), PS=PSA2
Where:
LIMS(P) is a limit value of heat producing operation change over time associated with injection of melt into the mold cavities
P(1) is the value of the heat producing operation of the controlled heating device in a zone controlled in response to measured temperature at the beginning of a predetermined time interval ΔTP
P(2) is the value of the heat producing operation of the controlled heating device in the same zone at the end of a predetermined time interval ΔTP
PS is the proportioning set point for a zone controlled without measured temperature
PSA1 is the first alternative proportioning set point value
PSA2 is the second alternative proportioning set point value.

19. The method according to claim 18 wherein the controlled heating device is an electrical heater and the value of the heat producing operation is computed in accordance with:
P=(IACT**2)*R
Where
IACT is electrical current delivered to the heater
R is electrical resistance of the heater
* designates multiplication
** designates exponentiation.

20. The method according to claim 17 wherein the occurrence of injection of melt into mold cavities is detected from a reduction of heat producing operation of the controlled heating device in a zone controlled in accordance with an algorithm relating set point temperature and measured temperature, and the selection of a set point for a zone for which measured temperature is not available is made in accordance with the following:
IF V(1)−V(2)<LIMS(V), PS=PSA1
IF V(1)−V(2))>LIMS(V), PS=PSA2
Where:
LIMS(V) is a limit value of control variable change over time associated with injection of melt into the mold cavities
V(1) is the control variable value at the beginning of a predetermined time interval ΔTP for the zone controlled in response to measured temperature
V(2) is the control variable value at the end of a predetermined time interval ΔTP for the same zone
PS is the proportioning set point
PSA1 is the first alternative proportioning set point value
PSA2 is the second alternative proportioning set point value and the variable V is one of the proportional, integral and derivative terms of a control algorithm of the form:
POUT=VP+VI+VD
In which
POUT is a percentage of heat producing operation of a controlled heating device (0≦SPOUT≦100)
VP is the proportional term=KP*TE(t)
KP is the constant of proportionality of the proportional term
TE(t) is the difference between actual temperature and set-point temperature at time “t”
VI is the integral term=KI*S(t)
KI is the constant of proportionality of the integral term
S(i) is a sum at the “i^{th}” computation=S(i−1)+TE*(Δti)
S(i−1) is the value of S from the immediately preceding computation of S
Δti is the computational time interval of the integral term
VD is the derivative term=KD(TE(d)−TE(d−1))/(Δtd)
KD is the constant of proportionality of the derivative term
TE(d) is the difference between actual temperature and set-point temperature at the “d^{th}” computation of VD
TE(d−1) is the difference between actual temperature and set-point temperature at the immediately preceding computation of VD
Δtd is the computational time interval of the derivative term.
